(19) United States
(12) Patent Application Publication
(10) Pub. No.: US 2006/0026249 A1
(43) Pub. Date: Feb. 2, 2006

(54) Information distribution system and information distribution method

(75) Inventors: Yusaku Morishita, Kanagawa (JP); Takashi Uchiyama, Kanagawa (JP); Takeru Horii, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC MOBILING, LTD.

(21) Appl. No.: 11/190,847

(22) Filed: Jul. 28, 2005

(30) Foreign Application Priority Data
Jul. 30, 2004 (JP) 223587/2004

(51) Int. Cl. G06F 15/16

(52) U.S. Cl. 709/206

(57) ABSTRACT

An information distribution system and an information distribution method in which a user can view content on a personal digital assistant without complicated operation, thereby obtaining detailed information from an information distributor efficiently without fail. An information distribution system comprises a personal digital assistant for viewing a distribution file delivered by an information distributor, a distribution file server for storing the distribution file to be delivered to the personal digital assistant, and a command mail server for storing as email a command to specify the personal digital assistant to which the distribution file is to be delivered. The command mail server sends the email to the personal digital assistant. The personal digital assistant determines whether or not the email is addressed thereto based on command information provided by the email. When the personal digital assistant has determined that the email is addressed thereto, it obtains a distribution file specified by the command information from the distribution file server, and outputs information from the distribution file to a display or a sound output device such as a speaker.

### FIELD OF THE INVENTION

The present invention relates to an information distribution system and an information distribution method in which an information distributor voluntarily provides information to a user using the Internet without a request from the user.

### BACKGROUND OF THE INVENTION

There has been known a display system for scroll displaying news, advertisements, etc. on a display in the shop window, train or the like. In such a display system, usually, a service provider sends the same messages such as news or advertisements of shops to subscribers (shops etc.) using a telephone line so that the subscribers can display the messages.

In Japanese Patent Application laid open No. HEI9-81447, there is disclosed a technique for obtaining information. In the technique, when a user requests information related to hypermedia information provided by FM teletext broadcasting, telephone number information is detected from the hypermedia information to specify a server. The user terminal is automatically connected to the server via a communication network such as a telephone line, an ISDN, or the like. Thereby, the information related to the information provided by broadcasting signals can be obtained according to need.

Additionally, it is common practice that a user receives the delivery of desired rich content via the Internet using a mobile phone with a built-in browser function, a portable personal computer (PC) or the like.

In Japanese Patent Application laid open No. 2003-233619, there is disclosed a technique for distributing content. In the technique, to provide guidance about a commercial complex or the like, a chip ID is read from an IC chip by a scanner. Based on the chip ID, the email address of a mobile telephone is specified to deliver content.

Besides, the staff of a railway company in the station, an airline company in the airport, etc. work to smoothly provide train or air services, and the work content of them varies according to constantly changing customers. In order to have better realization of the customer situation of the day and also handle troubles or accidents appropriately, the staff are required to make better contact with each other or with a business manager to discuss together or receive instructions while carrying out their duties.

Such work instructions have been given to the staff working in the station or airport by, for example, announcement over a public address system or through radio communication equipment carried by the staff. The staff may even have to visit the business manager to receive instructions.

However, if work instructions are given to the staff in the above manner: by announcement over a public address system, through radio communication equipment carried by the staff, or by a staff's visit to the business manager, the instructions do not always reach all the staff without fail. In addition, by announcement or through radio communication equipment, detailed instructions cannot be provided. Also, it is waste of time for the staff to travel to the place where the business manager is present for just receiving instructions. Such travel decreases operational efficiency.

Further, as is described above, it is pretty common now to receive the delivery of desired rich content via the Internet using a mobile phone with a built-in browser function, a portable PC or the like. However, users have to perform complicated key operation to view the content. Not every user who wishes to view content is familiar with the operating of the mobile phone or PC. For users who are unacquainted with the operation of such equipment, it is difficult to view desired content with the existing mobile phone or PC. Even when a user has a good knowledge of the mobile phone or PC, he/she may not bother to perform complicated operation while dealing with customers and miss or fail to notice important information necessary for him/her.

### SUMMARY OF THE INVENTION

It is therefore an object of the present invention to provide an information distribution system and an information distribution method, in which an information distributor voluntarily sends content to a personal digital assistant carried by a user, the user is informed of the receipt of the content on the personal digital assistant by, for example, a ringing tone, and the content is automatically displayed on the screen of the personal digital assistant. Thus, the user can inevitably and efficiently receive detailed information from the information distributor without complicated operation for viewing content.

In accordance with an aspect of the present invention, to achieve the object mentioned above, there is provided an information distribution system comprising a personal digital assistant for viewing a distribution file delivered by an information distributor, a distribution file server for storing the distribution file to be delivered to the personal digital assistant by the information distributor, and a command mail server for storing as email a command to specify the personal digital assistant to which the distribution file is to be delivered. The command mail server sends the email to the personal digital assistant. The personal digital assistant determines whether or not the email is addressed thereto based on command information provided by the email. When the personal digital assistant has determined that the email is addressed thereto, it obtains a distribution file specified by the command information from the distribution file server, and outputs information from the distribution file.

Preferably, the personal digital assistant includes: a network connection section for connecting the personal digital assistant to a network such as a wireless LAN or the Internet; a command mail acquisition section for accessing the command mail server at regular time intervals to check whether or not the server stores email to the personal digital assistant, and, when there is stored the email, receiving the email mail; a command analyzer for analyzing a command contained in the email obtained by the command mail acquisition section, and requesting a distribution file specified by the command information based on address information of the distribution file indicated by the command information; a distribution file acquisition section for downloading, in response to the request for the distribution file specified by the command information, the distribution file from the distribution file server; a distribution file executable selector for referring to the extension of the distribution file downloaded by the distribution file acquisition section to activate an application program corresponding to the extension, and passing the distribution file to the application program; a distribution file executor for executing the distribution file using the application program; a display controller for, when there is information to be displayed on a display as the result of the execution of the distribution file through the application program by the distribution file executor, performing display control to display the information on the display; the display for displaying the information under the control of the display controller; a sound output controller for, when there is information to be output by sound as the result of the execution of the distribution file through the application program by the distribution file executor, performing sound output control to output the information from a sound output device such as a speaker; and the sound output device such as a speaker for outputting the information under the control of the sound output controller.

Preferably, the command contained in the email provides the command information including at least information on the address of a distribution file, the output type or method of the distribution file and a password to specify the personal digital assistant. The personal digital assistant analyzes the command through the command analyzer to compare the password indicated by the command with a password assigned thereto. When the two passwords match, the personal digital assistant determines that the email is addressed thereto.

The information distribution system may further comprise an external output device that includes the display and the sound output device. In such a case, the personal digital assistant includes an external output device controller for controlling the external output device by sending a command to the external output device.

The personal digital assistant may further include a sounder for controlling the sound output device such as a speaker to produce sound simultaneously with the activation of the distribution file executor.

The personal digital assistant may include, in place of the network connection section, a first network connection section for receiving email and a second network connection section for receiving a distribution file.

The personal digital assistant may further include a dark power supply, in addition to a main power supply, to supply power to the network connection section or the first network connection section for receiving email and the second network connection section for receiving a distribution file. In such a case, if the personal digital assistant is accessed from the network when the main power supply is off and the dark power supply is on, the main power supply is controlled to be on, and when the main power supply is turned on, the command mail acquisition section is activated.

The information distribution system may further comprise, in place of the command mail server, a pager server for storing a pager message including text information. In such a case, the personal digital assistant includes, in place of the command mail acquisition section, a pager message acquisition section for obtaining the pager message stored in the pager server. The pager message acquisition section accesses, via a pager network and/or the network such as a wireless LAN or the Internet, the pager server at regular time intervals to check whether or not the server stores a pager message to the personal digital assistant, and, when there is stored the pager message, receives the pager message.

In accordance with another aspect of the present invention, there is provided an information distribution method applied to an information distribution system comprising a personal digital assistant for viewing a distribution file delivered by an information distributor, a distribution file server for storing the distribution file to be delivered to the personal digital assistant by the information distributor, and a command mail server for storing as email a command to specify the personal digital assistant to which the distribution file is to be delivered. The information distribution method comprises the steps of sending, by the command mail server, the email to the personal digital assistant; determining, by the personal digital assistant, whether or not the email is addressed thereto based on command information provided by the email; obtaining, by the personal digital assistant, a distribution file specified by the command information from the distribution file server when the personal digital assistant has determined that the email is addressed thereto; and outputting, by the personal digital assistant, information from the distribution file.

Preferably, the information distribution method comprises, in the personal digital assistant, the steps of connecting, by a network connection section, the personal digital assistant to a network such as a wireless LAN or the Internet; accessing, by a command mail acquisition section, the command mail server at regular time intervals to check whether or not the command mail server stores email to the personal digital assistant, and, when there is stored the email, receiving the email mail; analyzing, by a command analyzer, a command contained in the email obtained by the command mail acquisition section, and requesting a distribution file specified by the command information based on address information of the distribution file indicated by the command information; downloading, by a distribution file acquisition section, the distribution file from the distribution file server in response to the request for the distribution file specified by the command information; referring to, by a distribution file executable selector, the extension of the distribution file downloaded by the distribution file acquisition section to activate an application program corresponding to the extension, and passing the distribution file to the application program; executing, by a distribution file executor, the distribution file using the application program; performing, by a display controller, display control to display information on a display when there is information to be displayed on the display as the result of the execution of the distribution file through the application program by the distribution file executor; displaying, by the display, the information under the control of the display controller; performing, by a sound output controller, sound output control to output information from a sound output device such as a speaker when there is information to be output by sound as the result of the execution of the distribution file through the application program by the distribution file executor; and outputting, by the sound output device such as a speaker, the information under the control of the sound output controller.

Preferably, the command contained in the email provides the command information including at least information on the address of a distribution file, the output type or method of the distribution file and a password to specify the personal digital assistant, and the information distribution method further comprises, in the personal digital assistant, the steps of analyzing, by the command analyzer, the command to compare the password indicated by the command with a password assigned thereto; and determining that the email is addressed to the personal digital assistant when the two passwords match.

The information distribution method may further comprise, when the information distribution system further comprises an external output device that includes the display and the sound output device, and the personal digital assistant includes an external output device controller for controlling the external output device, the step of controlling, by the personal digital assistant, the external output device by sending a command thereto.

The information distribution method may further comprise, when the personal digital assistant further includes a sounder, the step of controlling, by the sounder, the sound output device such as a speaker to produce sound simultaneously with the activation of the distribution file executor.

The information distribution method may further comprise, when the personal digital assistant includes, in place of the network connection section, a first network connection section for receiving email and a second network connection section for receiving a distribution file, the step of, by the respective first and second connecting sections, connecting to the network.

The information distribution method may further comprise, when the personal digital assistant further includes a dark power supply, in addition to a main power supply, to supply power to the network connection section or the first network connection section for receiving email and the second network connection section for receiving a distribution file, the steps of: controlling the main power supply to be on in the case where the personal digital assistant is accessed from the network when the main power supply is off and the dark power supply is on; and activating the command mail acquisition section when the main power supply is turned on.

The information distribution method may further comprise, when the information distribution system further comprises, in place of the command mail server, a pager server for storing a pager message including text information, and the personal digital assistant includes, in place of the command mail acquisition section, a pager message acquisition section for obtaining the pager message stored in the pager server, the steps of accessing, by the pager message acquisition section, the pager server at regular time intervals via a pager network and/or the network such as a wireless LAN or the Internet to check whether or not the pager server stores a pager message to the personal digital assistant, and, when there is stored the pager message, receiving the pager message.

### BRIEF DESCRIPTION OF THE DRAWINGS

The exemplary aspects and features of the present invention will become more apparent from the consideration of the following detailed description taken in conjunction with the accompanying drawings in which:

FIG. 1 is a block diagram showing the construction of an information distribution system according to the first embodiment of the present invention;

FIG. 2 is a diagram for explaining command mail according to the first embodiment of the present invention;

FIG. 3 is a flowchart showing the operation of the information distribution system depicted in FIG. 1;

FIG. 4 is a block diagram showing the construction of an information distribution system according to the second embodiment of the present invention;

FIG. 5 is a block diagram showing the construction of an information distribution system according to the third embodiment of the present invention;

FIG. 6 is a block diagram showing the construction of an information distribution system according to the fourth embodiment of the present invention;

FIG. 7 is a block diagram showing the construction of an information distribution system according to the fifth embodiment of the present invention; and

FIG. 8 is a block diagram showing the construction of an information distribution system according to the sixth embodiment of the present invention.

### DESCRIPTION OF THE PREFERRED EMBODIMENTS

Referring now to the drawings, a description of preferred embodiments of the present invention will be given in detail.

According to an preferred embodiment of the present invention, an information distribution system comprises a personal digital assistant for viewing a distribution file delivered by an information distributor, a distribution file server for storing the distribution file to be delivered to the personal digital assistant by the information distributor, and a command mail server for storing as email a command to specify the personal digital assistant to which the distribution file is to be delivered. The command mail server sends email to the personal digital assistant. Having received the email, the personal digital assistant determines whether or not the email is addressed thereto based on command information provided by the email. When having determined that the email is addressed thereto, the personal digital assistant obtains a distribution file specified by the command information from the distribution file server, and outputs information from the distribution file.

### First Embodiment

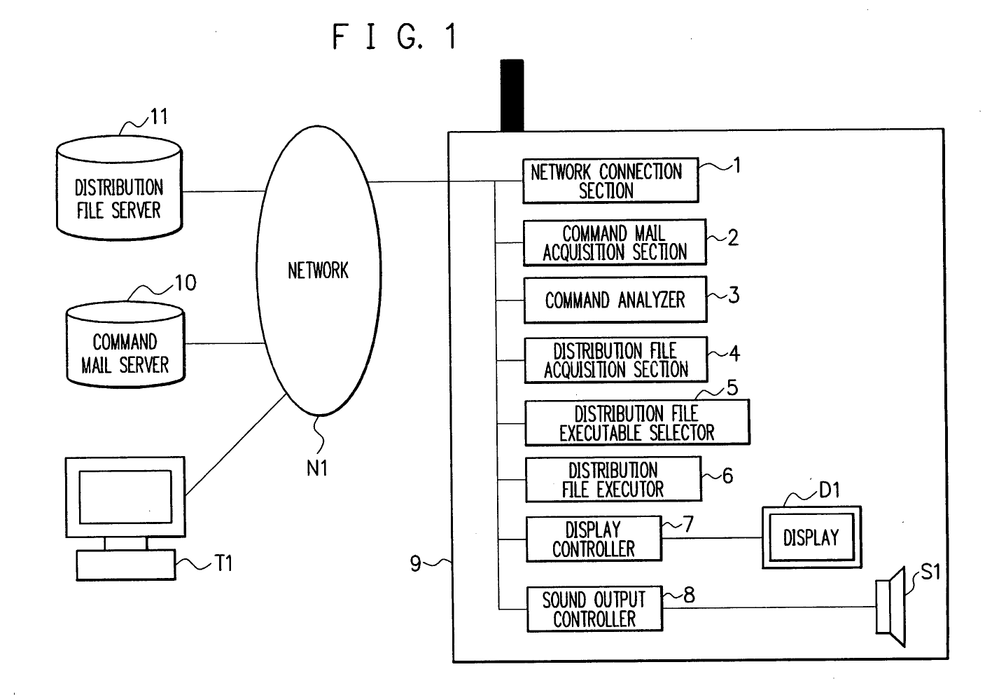

FIG. 1 is a block diagram showing the construction of an information distribution system according to the first embodiment of the present invention. Referring to FIG. 1, a description will be given of the construction and functions of the information distribution system of this embodiment.

As can be seen in FIG. 1, the information distribution system comprises a PDA (Personal Digital Assistant) 9, a command mail server 10, a distribution file server 11, and a command transmitter terminal T1, which are connected via a network N1 such as the Internet.

The PDA 9 includes a network connection section 1, a command mail acquisition section 2, a command analyzer 3, a distribution file acquisition section 4, a distribution file executable selector 5, distribution file executor 6, a display controller 7, a sound output controller 8, a display D1, and a speaker S1.

The network connection section 1 connects the PDA 9 to a wireless network such as a wireless LAN or a mobile communication network, and especially, to the network N1 where Internet protocols (IP) are used.

The command mail acquisition section 2 accesses the command mail server 10 at regular time intervals to receive command mail, and obtains a command contained in the text of the command mail.

The command analyzer 3 verifies the password of the command obtained by the command mail acquisition section 2, and, when the password is correct, performs prescribed processes following the command.

The distribution file acquisition section 4 downloads, according to an instruction from the command analyzer 3, a distribution file specified by address information.

The distribution file executable selector 5 refers to the extension of the distribution file downloaded by the distribution file acquisition section 4 to pass the file to an application program designated by the extension.

The distribution file executor 6 executes the distribution file using the application program installed on the PDA 9 in advance.

The display controller 7 performs display control to output the execution result obtained by the distribution file executor 6 to the display D1.

The sound output controller 8 performs sound output control, when sound output is required, to output the execution result obtained by the distribution file executor 6 to the speaker S1.

The command transmitter terminal T1 is used by an information distributor to input a command for sending command mail to the email address of the PDA 9. The command transmitter terminal T1 sends the command input by the information distributor in the form of command mail to the command mail server 10.

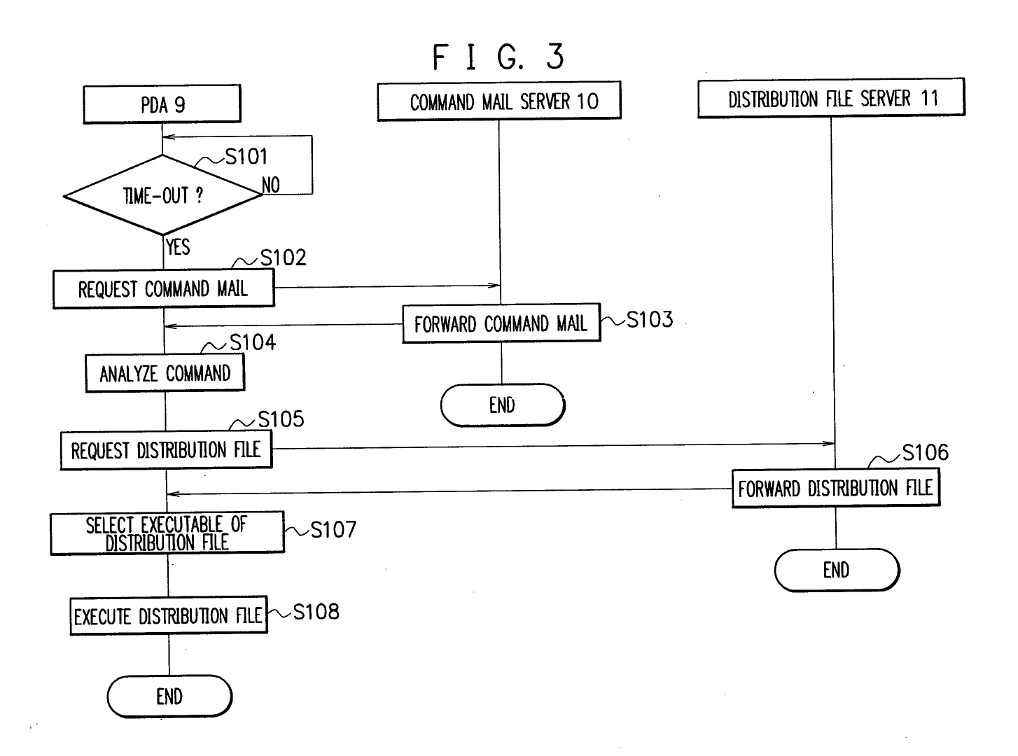

FIG. 3 is a flowchart showing the operation of the information distribution system of this embodiment. Referring to FIGS. 1, 2 and 3, a description will be given of the operation of the information distribution system.

For the purpose of the explanations given hereinafter, it will be assumed that the distribution file server 11 has already stored a distribution file to be delivered to the PDA 9, and the command mail server 10 has received command mail from the command transmitter terminal T1 which is to be forwarded to the PDA 9 based on the email address thereof.

First, as shown in FIG. 3, the command mail acquisition section 2 accesses the command mail server 10 at regular time intervals counted by a timer (not shown) set in the PDA 9 (step S101/YES) to send command mail request information thereto (step S102). Having received the command mail request information, the command mail server 10 forwards command mail to the PDA 9 (step S103). After the PDA 9 receives the command mail, the command analyzer 3 analyzes the command mail (step S104).

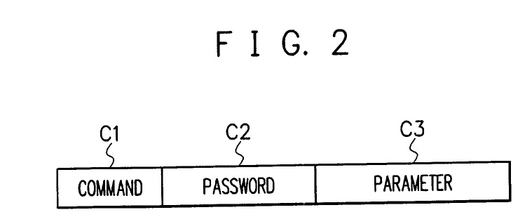

FIG. 2 is a diagram showing an example of the command format of command mail sent from the command transmitter terminal T1 to the PDA 9 according to the first embodiment. In the following, the command format of the command mail will be described referring to FIG. 2.

As can be seen in FIG. 2, the command format of the command mail consists of three fields, in high-to-low order of octet, a command C1, a password C2 and a parameter C3. The parameter C3 includes information on the address of a file to be delivered to the PDA 9, a indication method or type and the like.

The command analyzer 3 verifies the password C2 of the command mail obtained by the command mail acquisition section 2. When the password C2 is correct, the command analyzer 3 performs prescribed processes following the command C1 of the command mail. In addition, the command analyzer 3 accesses the distribution file server 11 based on address information of a distribution file contained in the parameter C3 to send distribution file request information for the file to the server 11 (step S105). On the other hand, when the password C2 is incorrect, the command analyzer 3 discards the command mail without sending distribution file request information to the server 11 in step S105. Upon receipt of the distribution file request information, the distribution file server 11 sends the distribution file requested by the request information to the PDA 9 (step S106).

The distribution file executable selector 5 refers to the extension of the distribution file downloaded from the distribution file server 11 to the PDA 9 in step S106 to select the executable program of the file, thereby passing the file to the appropriate application program (step S107).

The distribution file executor 6 executes, for the distribution file, the application program (step S108). As the result of the execution of the application program, if there is information to be visually output, the display controller 7 performs display control to display the information on the display D1. If there is information to be vocally output, the sound output controller 8 performs sound output control to output the information from the speaker S1.

As is described above, according to the first embodiment of the present invention, the information distribution system voluntarily delivers detailed information or rich content that contains sounds, images or the like to one or more specific users who carry a personal digital assistant. Consequently, the users are not required to perform complicated operation on the personal digital assistant to obtain the information. In cases, as for example where detailed information or rich content is delivered via a wireless line to a personal digital assistant carried by a field staff, the staff can acquire the detailed information on work instructions including plans etc. without operating the personal digital assistant.

### Second Embodiment

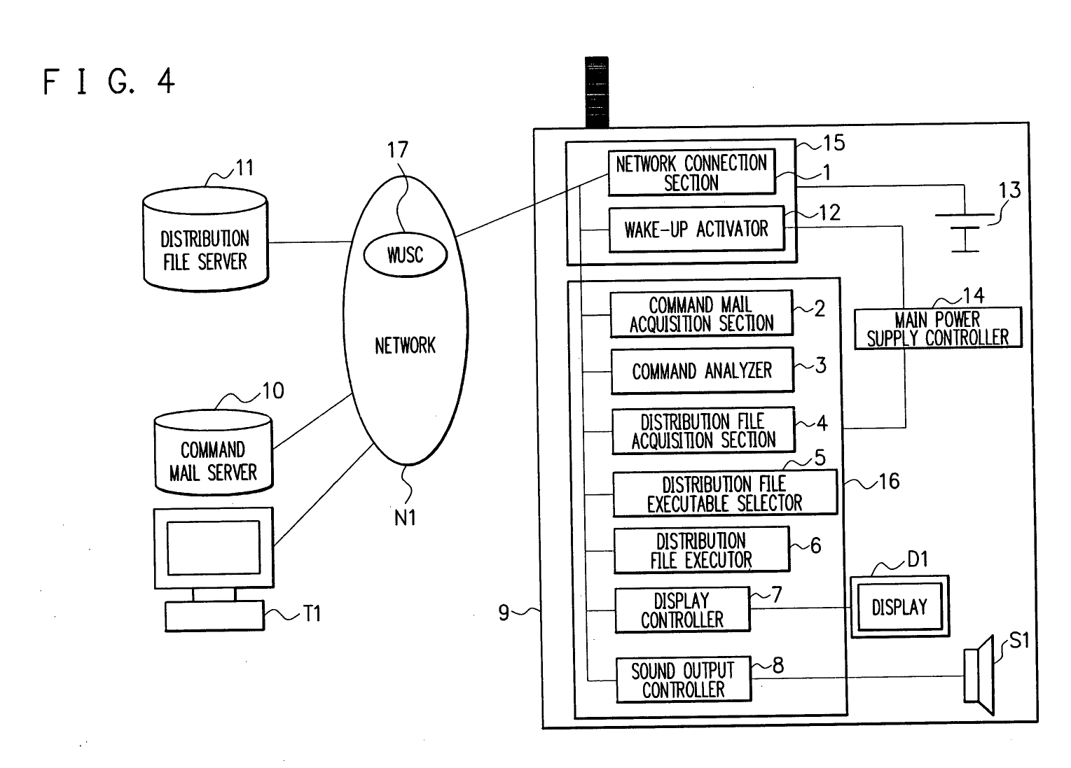

FIG. 4 is a block diagram showing the construction of an information distribution system according to the second embodiment of the present invention. Referring to FIG. 4, a description will be given of the construction and functions of the information distribution system of this embodiment.

As can be seen in FIG. 4, the information distribution system of this embodiment is in many respects basically similar to that of the first embodiment except for the presence of a wake-up service center 17. Further, the PDA 9 of this embodiment includes, differently from that of the first embodiment, a wake-up activator 12, a dark power supply 13, a main power supply controller 14, a dark power supplied section 15, and a main power supplied section 16. The dark power supplied section 15 includes the network connection section 1 and the wake-up activator 12.

The wake-up service center 17 is a service center provided by a communication carrier or the like. In this embodiment, it is assumed that the user has a contract with the wake-up service center 17 to receive the service. The network connection section 1 and the wake-up activator 12 in the dark power supplied section 15 have a power supply system different from that of the main power supplied section 16, and are always being fed with power by the dark power supply 13.

Referring to FIG. 4, a description will be given of the operation of the information distribution system to obtain command mail through the wake-up process. Incidentally, for the purpose of the explanations given hereinafter, it will be assumed that the distribution file server 11 has already stored a distribution file to be delivered to the PDA 9.

When the main power of the PDA 9 is off, the command mail server 10 sends wake-up request information as to the PDA 9 to the wake-up service center 17 as well as command mail to the email address of the PDA 9. Having received the wake-up request information, the wake-up service center 17 performs a wake-up activation sequence with respect to the PDA 9. Accordingly, the wake-up activator 12 instructs the main power supply controller 14 to turn on the main power of the PDA 9. Thereby, the main power supply controller 14 supplies power to the main power supplied section 16.

After the main power supplied section 16 is fed with power, the command mail acquisition section 2 automatically accesses the command mail server 10 to obtain command mail.

When the PDA 9 has received the command mail through the operation of the command mail acquisition section 2, the command analyzer 3 analyzes the command mail. Thereafter, the information distribution system operates in the same manner as described previously for that of the first embodiment in connection with FIG. 3.

As is described above, according to the second embodiment of the present invention, when, for example, the user has forgotten to turn on his/her personal digital assistant and it is off at the time of information distribution, the personal digital assistant is automatically turned on. Thereby, the information distribution system can always provide information as a distribution file to the user. Thus, it is possible to deliver the information to the user without fail.

### Third Embodiment

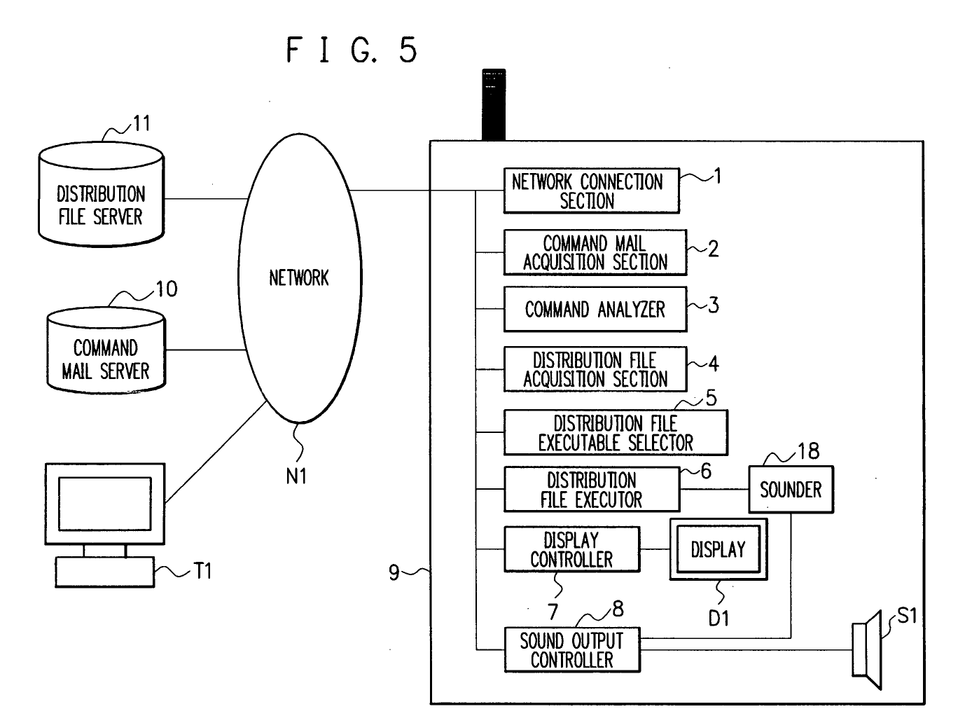

FIG. 5 is a block diagram showing the construction of an information distribution system according to the third embodiment of the present invention. Referring to FIG. 5, a description will be given of the construction and operation of the information distribution system of this embodiment. Incidentally, the same description as previously given for the first embodiment will not be repeated.

As can be seen in FIG. 5, the information distribution system of this embodiment has essentially the same construction as that of the first embodiment except that the PDA 9 of this embodiment further includes a sounder 18.

When having executed a distribution file downloaded from the distribution file server 11, the distribution file executor 6 instructs the sounder 18 to produce sound for indicating that the file has been executed. In response to the instruction from the distribution file executor 6, the sounder 18 instructs the sound output controller 8 to perform sound output control to output sound from the speaker S1 so that the user can be informed of the receipt and output of the distribution file. According to the instruction from the sounder 18, the sound output controller 8 controls the speaker S1 to make sound.

### Fourth Embodiment

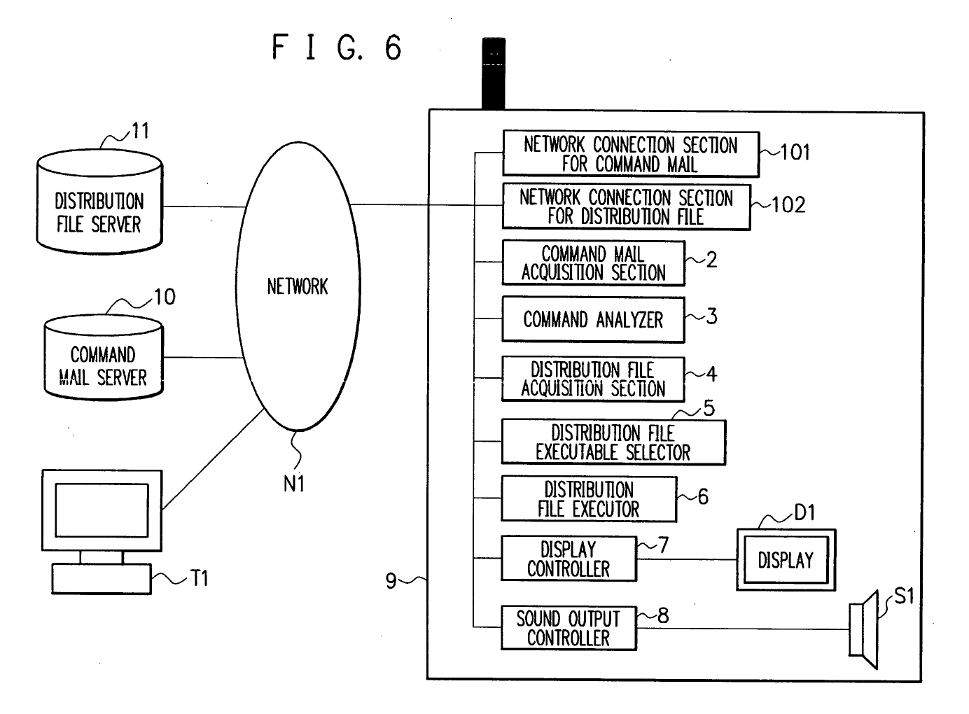

FIG. 6 is a block diagram showing the construction of an information distribution system according to the fourth embodiment of the present invention. Referring to FIG. 6, a description will be given of the construction and functions of the information distribution system of this embodiment. Incidentally, the same description as previously given for the first embodiment will not be repeated.

As can be seen in FIG. 6, the information distribution system of this embodiment has essentially the same construction as that of the first embodiment except that the PDA 9 of this embodiment includes a network connection section for command mail 101 and a network connection section for distribution file 102 in place of the network connection section 1. The network connection section for command mail 101 is dedicated to receiving command mail, while the network connection section for distribution file 102 is dedicated to downloading a distribution file.

The volume of data of command mail is very small. In the information distribution system which monitors the conditions of command mail distribution at regular time intervals, as the number of command mail receipts increase, more real-time information can be obtained. Therefore, data communication speed is not really important to receive command mail. It is preferable to use a low-speed always-on connection data communication line that requires less cost. Thus, the network connection section for command mail 101 is connected to such a communication line.

On the other hand, a distribution file contains a large volume of data, and needs a high-speed data communication line. Accordingly, the network connection section for distribution file 102 is connected to such a communication line.

As is described above, according to the fourth embodiment of the present invention, different communication lines are used to receive command mail and a distribution file, respectively. For receipt of command mail having a small amount of data and requiring frequent connection, low-speed always-on connection type packet communication can be utilized. Meanwhile, for receipt of a distribution file having a large amount of data and requiring less frequent connection, high speed circuit switched data communication can be utilized. That is, by selecting an appropriate communication line depending on the intended use, the information distribution system can be managed efficiently with less communication cost.

### Fifth Embodiment

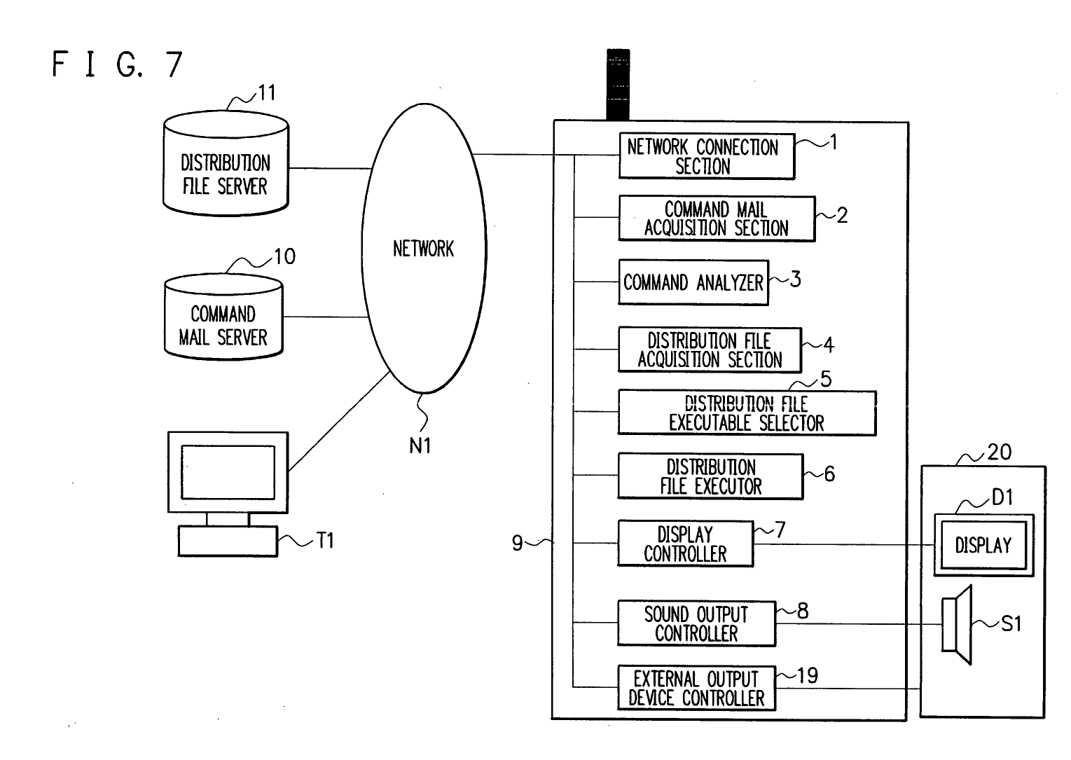

FIG. 7 is a block diagram showing the construction of an information distribution system according to the fifth embodiment of the present invention. Referring to FIG. 7, a description will be given of the construction and functions of the information distribution system of this embodiment. Incidentally, the same description as previously given for the first embodiment will not be repeated.

As can be seen in FIG. 7, the information distribution system of this embodiment has essentially the same construction as that of the first embodiment except for the presence of an external output device 20. Further, the PDA 9 of this embodiment includes an external output device controller 19 in place of the display D1 and the speaker S1. The external output device controller 19 controls the external output device 20 including the display D1 and the speaker S1.

As is described above, according to the fifth embodiment of the present invention, even a staff who does not carry a personal digital assistant can acquire detailed information from distributed rich content etc. displayed on an external large display placed in the work site. In addition, by outputting sound with a certain amount of volume from an external speaker, all staff notice incoming information, thus obtaining the information without fail.

### Sixth Embodiment

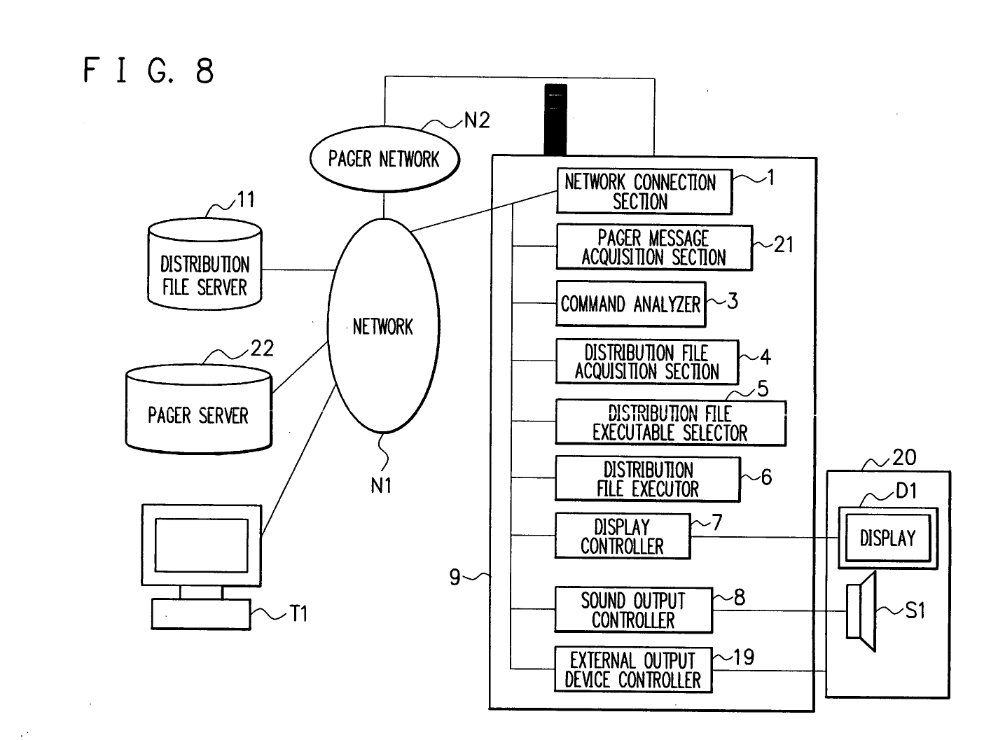

FIG. 8 is a block diagram showing the construction of an information distribution system according to the sixth embodiment of the present invention. Referring to FIG. 8, a description will be given of the construction and functions of the information distribution system of this embodiment. Incidentally, the same description as previously given for the first embodiment will not be repeated.

As can be seen in FIG. 8, the information distribution system of this embodiment has essentially the same construction as that of the first embodiment except for the presence of a pager network N2 and a pager server 22 in place of the command mail server 10. Further, the PDA 9 of this embodiment includes a pager message acquisition section 21 in place of the command mail acquisition section 2. In this embodiment, a command input to the command transmitter terminal T1 is transmitted in the form of a pager message as text information via the pager network N2.

As set forth hereinabove, in accordance with the present invention, an information distributor voluntarily sends content to a personal digital assistant carried by a user. The user is informed of the receipt of the content on the personal digital assistant by, for example, a ringing tone, and the content is automatically output, for example, to the display of the personal digital assistant. Thus, the user can inevitably and efficiently receive detailed information from the information distributor without complicated operation for viewing content.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An information distribution system comprising:
a personal digital assistant for viewing a distribution file delivered by an information distributor;
a distribution file server for storing the distribution file to be delivered to the personal digital assistant by the information distributor; and
a command mail server for storing as email a command to specify the personal digital assistant to which the distribution file is to be delivered; wherein:
the command mail server sends the email to the personal digital assistant;
the personal digital assistant determines whether or not the email is addressed thereto based on command information provided by the email; and
when the personal digital assistant has determined that the email is addressed thereto, the personal digital assistant obtains a distribution file specified by the command information from the distribution file server, and outputs information from the distribution file.

2. The information distribution system according to claim 1, wherein the personal digital assistant includes:
a network connection section for connecting the personal digital assistant to a network such as a wireless LAN or the Internet;
a command mail acquisition section for accessing the command mail server at regular time intervals to check whether or not the command mail server stores email to the personal digital assistant, and, when there is stored the email, receiving the email mail;
a command analyzer for analyzing a command contained in the email obtained by the command mail acquisition section, and requesting a distribution file specified by the command information based on address information of the distribution file indicated by the command information;
a distribution file acquisition section for downloading, in response to the request for the distribution file specified by the command information, the distribution file from the distribution file server;
a distribution file executable selector for referring to the extension of the distribution file downloaded by the distribution file acquisition section to activate an application program corresponding to the extension, and passing the distribution file to the application program;
a distribution file executor for executing the distribution file using the application program;
a display controller for, when there is information to be displayed on a display as the result of the execution of the distribution file through the application program by the distribution file executor, performing display control to display the information on the display;
the display for displaying the information under the control of the display controller;
a sound output controller for, when there is information to be output by sound as the result of the execution of the distribution file through the application program by the distribution file executor, performing sound output control to output the information from a sound output device such as a speaker; and
the sound output device such as a speaker for outputting the information under the control of the sound output controller.

3. The information distribution system according to claim 2, wherein:
the command contained in the email provides the command information including at least information on the address of a distribution file, the output type of the distribution file and a password to specify the personal digital assistant;
the personal digital assistant analyzes the command through the command analyzer to compare the password indicated by the command with a password assigned thereto; and
when the two passwords match, the personal digital assistant determines that the email is addressed thereto.

4. The information distribution system according to claim 2, further comprising an external output device that includes the display and the sound output device, wherein the personal digital assistant includes an external output device controller for controlling the external output device by sending a command to the external output device.

5. The information distribution system according to claim 2, wherein the personal digital assistant further includes a sounder for controlling the sound output device such as a speaker to produce sound simultaneously with the activation of the distribution file executor.

6. The information distribution system according to claim 2, wherein the personal digital assistant includes, in place of the network connection section, a first network connection section for receiving email and a second network connection section for receiving a distribution file.

7. The information distribution system according to claim 2, wherein:
the personal digital assistant further includes a dark power supply, in addition to a main power supply, to supply power to the network connection section;
in the case where the personal digital assistant is accessed from the network when the main power supply is off and the dark power supply is on, the main power supply is controlled to be on; and
when the main power supply is turned on, the command mail acquisition section is activated.

8. The information distribution system according to claim 2, further comprising, in place of the command mail server, a pager server for storing a pager message including text information, wherein:
the personal digital assistant includes, in place of the command mail acquisition section, a pager message acquisition section for obtaining the pager message stored in the pager server; and
the pager message acquisition section accesses, via a pager network and/or the network such as a wireless LAN or the Internet, the pager server at regular time intervals to check whether or not the pager server stores a pager message to the personal digital assistant, and, when there is stored the pager message, receives the pager message.

9. An information distribution method applied to an information distribution system comprising:
a personal digital assistant for viewing a distribution file delivered by an information distributor;
a distribution file server for storing the distribution file to be delivered to the personal digital assistant by the information distributor; and
a command mail server for storing as email a command to specify the personal digital assistant to which the distribution file is to be delivered; the method comprising the steps of:
sending, by the command mail server, the email to the personal digital assistant;
determining, by the personal digital assistant, whether or not the email is addressed thereto based on command information provided by the email;
obtaining, by the personal digital assistant, a distribution file specified by the command information from the distribution file server when the personal digital assistant has determined that the email is addressed thereto; and
outputting, by the personal digital assistant, information from the distribution file.

10. The information distribution method according to claim 9, comprising, in the personal digital assistant, the steps of:
connecting, by a network connection section, the personal digital assistant to a network such as a wireless LAN or the Internet;
accessing, by a command mail acquisition section, the command mail server at regular time intervals to check whether or not the command mail server stores email to the personal digital assistant, and, when there is stored the email, receiving the email mail;
analyzing, by a command analyzer, a command contained in the email obtained by the command mail acquisition section, and requesting a distribution file specified by the command information based on address information of the distribution file indicated by the command information;
downloading, by a distribution file acquisition section, the distribution file from the distribution file server in response to the request for the distribution file specified by the command information;
referring to, by a distribution file executable selector, the extension of the distribution file downloaded by the distribution file acquisition section to activate an application program corresponding to the extension, and passing the distribution file to the application program;
executing, by a distribution file executor, the distribution file using the application program;
performing, by a display controller, display control to display information on a display when there is information to be displayed on the display as the result of the execution of the distribution file through the application program by the distribution file executor;
displaying, by the display, the information under the control of the display controller;
performing, by a sound output controller, sound output control to output information from a sound output device such as a speaker when there is information to be output by sound as the result of the execution of the distribution file through the application program by the distribution file executor; and
outputting, by the sound output device such as a speaker, the information under the control of the sound output controller.

11. The information distribution method according to claim 10, wherein the command contained in the email provides the command information including at least information on the address of a distribution file, the output type of the distribution file and a password to specify the personal digital assistant; the method further comprising, in the personal digital assistant, the steps of:
analyzing, by the command analyzer, the command to compare the password indicated by the command with a password assigned thereto; and
determining that the email is addressed to the personal digital assistant when the two passwords match.

12. The information distribution method according to claim 10, wherein the information distribution system further comprises an external output device that includes the display and the sound output device, and the personal digital assistant includes an external output device controller for controlling the external output device, the method further comprising the step of controlling, by the personal digital assistant, the external output device by sending a command thereto.

13. The information distribution method according to claim 10, wherein the personal digital assistant further includes a sounder, the method further comprising the step of controlling, by the sounder, the sound output device such as a speaker to produce sound simultaneously with the activation of the distribution file executor.

14. The information distribution method according to claim 10, wherein the personal digital assistant includes, in place of the network connection section, a first network connection section for receiving email and a second network connection section for receiving a distribution file, the method further comprising the step of, by the respective first and second connecting sections, connecting to the network.

15. The information distribution method according to claim 10, wherein the personal digital assistant further includes a dark power supply, in addition to a main power supply, to supply power to the network connection section, the method further comprising the steps of:
controlling the main power supply to be on in the case where the personal digital assistant is accessed from the network when the main power supply is off and the dark power supply is on; and
activating the command mail acquisition section when the main power supply is turned on.

16. The information distribution method according to claim 10, wherein the information distribution system further comprises, in place of the command mail server, a pager server for storing a pager message including text information, and the personal digital assistant includes, in place of the command mail acquisition section, a pager message acquisition section for obtaining the pager message stored in the pager server, the method further comprising the steps of accessing, by the pager message acquisition section, the pager server at regular time intervals via a pager network and/or the network such as a wireless LAN or the Internet to check whether or not the pager server stores a pager message to the personal digital assistant, and, when there is stored the pager message, receiving the pager message.
